(19) United States
(12) Patent Application Publication
(10) Pub. No.: US 2004/0252028 A1
(43) Pub. Date: Dec. 16, 2004

(54) Furnace sensor and alarm system

(76) Inventors: Earl J. Odd JR., Appleton, ME (US); Jeannette M. Odd, Appleton, ME (US)

Correspondence Address: DONALD R. SCHOONOVER, 4211 ROLLING HILLS DRIVE, NIXA, MO, 65714-8771, US

(21) Appl. No.: 10/462,060

(22) Filed: Jun. 16, 2003

(51) Int. Cl. G08B 17/00

(52) U.S. Cl. 340/584

(57) ABSTRACT

A sensor and alarm system is associated with a furnace and includes alarm units that can be remotely located from the furnace. The alarm units can signal when the furnace is malfunctioning and can generate alarm signals in a plurality of modes.

### BACKGROUND OF THE INVENTION

1. Field of the Invention

The present invention relates to the general art of furnaces, and to the particular field of sensors and alarms associated with furnaces.

2. Discussion of the Related Art

Many climates experience periods of weather wherein ambient temperature is below, sometimes substantially below, freezing for some time, and in some cases, extended periods of time. Structures, such as homes or the like located in such climates are subject to these sub-freezing temperatures. These structures are generally insulated accordingly.

Most structures of the type mentioned above also include water pipes as well as other fluid-containing elements. Should such fluid-containing elements be exposed to sub-freezing temperatures for extended times, fluid in the elements may freeze. As is well understood, if fluid in a fluid-containing element freezes, that element may rupture. A ruptured fluid-containing element can be disastrous for a home owner or for anyone in the structure.

While many fluid-containing elements are located inside a heated structure, should the heating system in the structure fail, the temperature inside the structure may fall to sub-freezing levels after a time.

While fluid-containing elements, such as water pipes, have been mentioned above, those skilled in the art will recognize that there are other temperature-sensitive items and elements that are located in a structure such as a house that may be damaged by exposure to low temperatures.

Therefore, there is a need for a system which can be used to prevent ambient temperature in a structure, such as a house, from falling below a level which would create a condition in which temperature-sensitive devices in the structure may be damaged due to the ambient temperature in the structure.

While the inventor is aware of devices that will automatically shut off a furnace under certain conditions, such as loss of a pilot light, the inventor is not aware of any system that will alert someone that a furnace has malfunctioned in a manner which may create a condition in which ambient temperature in a structure, such as a residence, may be in danger of falling below a preset temperature.

In order to ensure that the proper person is alerted, any alarm associated with the above-discussed system should be located in a position most likely to alert the proper personnel.

While a location immediately adjacent to a furnace is an effective location for a sensor, this is generally not the most effective location for an alarm since many furnaces are located in remote areas of a structure. For example, a non-resident property owner may be the most effective person to alert if a furnace is malfunctioning. Furthermore, if a homeowner has a neighbor look in on his home to monitor the furnace while the homeowner is away for an extended period of time, that monitor will not be present on the premises for extended periods of time. Since water damage caused by ruptured pipes is so devastating and can occur quite rapidly, it will do little good if a person's home is being monitored by someone else and a significant amount of time elapses between checks of the home and a water pipe ruptures during such time lapse.

Still further, while being spaced immediately adjacent to a furnace is an effective location for a sensor, sensors could also be located near those elements that are most sensitive to ambient temperature as well.

Therefore, there is a need for a system which can be used to prevent ambient temperature in a structure, such as a house, from falling below a level which would create a condition in which temperature-sensitive devices in the structure may be damaged due to the ambient temperature in the structure and which has elements thereof that can be positioned in the most effective location.

Still further, while many alarms from condition-monitoring systems are audible, to be most effective an alarm should utilize as many modes as reasonably possible.

Therefore, there is a need for a system which can be used to prevent ambient temperature in a structure, such as a house, from falling below a level which would create a condition in which temperature-sensitive devices in the structure may be damaged due to the ambient temperature in the structure which can use a plurality of alarm signal modes.

In some cases, a furnace will fail long before the temperature in a location remote from the furnace noticeably falls. Thus, for example, in an office building, those on upper floors may not notice a falling temperature in the environment around them for some time after a furnace fails. However, if those people could be warned well ahead of the time they notice the falling ambient temperature, those people may be able to take proper actions, such as notifying the proper personnel, protecting temperature sensitive equipment or the like. Such early warning may save time and expense in many instances.

Therefore, there is a need for a system which can be used as an early warning system to warn that a furnace is not properly functioning and ambient temperature in locations remote from the furnace is in danger of falling below a pre-set level.

### PRINCIPAL OBJECTS OF THE INVENTION

It is a main object of the present invention to provide a system which can be used to prevent ambient temperature in a structure, such as a house, from falling below a level which would create a condition in which temperature-sensitive devices in the structure may be damaged due to the ambient temperature in the structure.

It is another object of the present invention to provide a system which can be used to prevent ambient temperature in a structure, such as a house, from falling below a level which would create a condition in which temperature-sensitive devices in the structure may be damaged due to the ambient temperature in the structure and which has elements thereof that can be positioned in the most effective location.

It is another object of the present invention to provide a system which can be used to prevent ambient temperature in a structure, such as a house, from falling below a level which would create a condition in which temperature-sensitive devices in the structure may be damaged due to the ambient temperature in the structure which can use a plurality of alarm signal modes.

It is another object of the present invention to provide a system which can be used as an early warning system to warn that a furnace is not properly functioning and ambient temperature in locations remote from the furnace is in danger of falling.

### SUMMARY OF THE INVENTION

These, and other, objects are achieved by a furnace sensor and alarm system which includes a temperature sensor located near a furnace to detect the temperature near the furnace and an alarm system located remotely from the furnace which will generate alarm signals in a plurality of modes and at a plurality of locations when temperature falling below a pre-set level is sensed by the temperature sensor.

The system embodying the present invention thus can be used to prevent ambient temperature in a structure, such as a house, from falling below a level which would create a condition in which temperature-sensitive devices in the structure may be damaged due to the ambient temperature in the structure. The system also can have an alarm signal that has a high likelihood of being noticed by someone who is most likely to take corrective action, and can be used as an early warning that ambient temperature is in danger of falling below a predetermined level unless corrective action is taken.

### BRIEF DESCRIPTION OF THE DRAWING FIGURES

FIG. 1 shows a structure containing the system embodying the present invention.

FIG. 2 shows the system embodying the present invention.

FIG. 3 is a perspective view of an alarm signal generator used in the system of the present invention.

### DETAILED DESCRIPTION OF THE PREFERRED EMBODIMENT

Other objects, features and advantages of the invention will become apparent from a consideration of the following detailed description and the accompanying drawings.

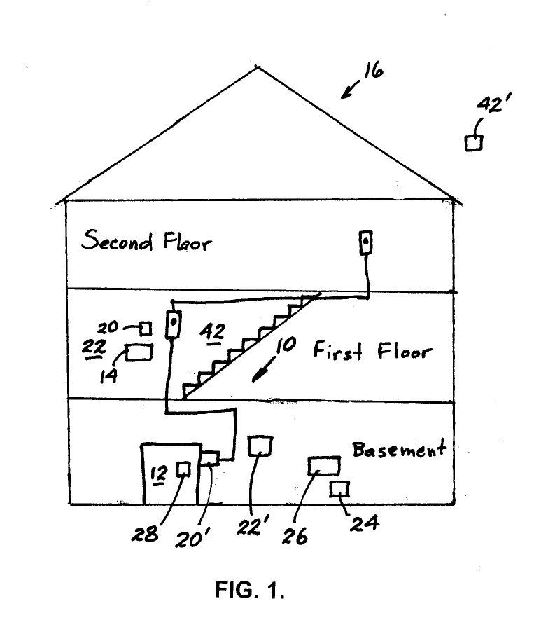

Referring to the figures, it can be understood that the present invention is embodied in a furnace sensor and alarm system 10 that can be used to monitor the operation of a furnace and to effectively alert the personnel that will be most likely to take action to correct any malfunction in the furnace. System 10 includes a furnace 12 which generates heated air. A heated air exit 14 is fluidically connected to the furnace. Heated air exit 14 can be a convector or the like and can be located in any suitable location in building 16. While only one heated air exit is shown in FIG. 1, those skilled in the art will understand that a building can contain a multiplicity of such air exits.

A sensor 20 is mounted on a support surface, such as wall 22, near the heated air exit or near the furnace as indicated as sensor 22′, or at any other suitable location, such as near a temperature-sensitive element as indicated by sensor 24 located near a fluid-containing element, such as water pipe 26. A heat sensor 28 can also be located inside the furnace 12 immediately adjacent to the heat generating element or elements of the furnace. Those skilled in the art will understand that the sensors can be located throughout the building as suitable.

It is noted that if sensor 28 is used, an early warning can be obtained that the furnace 12 is not working. Those in the remainder of the building may still be experiencing proper ambient temperature when the furnace 12 fails; however, this situation will not continue as the temperature will fall because the furnace 12 is malfunctioning. However, the sensor 28 will sense the furnace 12 malfunction before ambient temperature in a remote room noticeably falls so the proper personnel can take appropriate action to prevent the ambient temperatures in locations remote from the furnace 12 from falling or to protect the people or equipment or the like in such remote locations from low temperatures.

Each of the sensors includes a temperature sensing element 32, such as a thermocouple or the like, a signal generator 34, such as an alarm circuit or the like in the temperature sensing element 32 which generates an alarm signal when the temperature sensing element 32 senses a temperature below a pre-set level. An alarm circuit 36 is connected to the signal generator 34 of the temperature sensing element 32 to receive an alarm signal from the signal generator 34 and to be activated by the alarm signal received therefrom. A temperature level-setting circuit 38 is connected to the temperature sensing element 32 to control the pre-set level at which the alarm signal is generated.

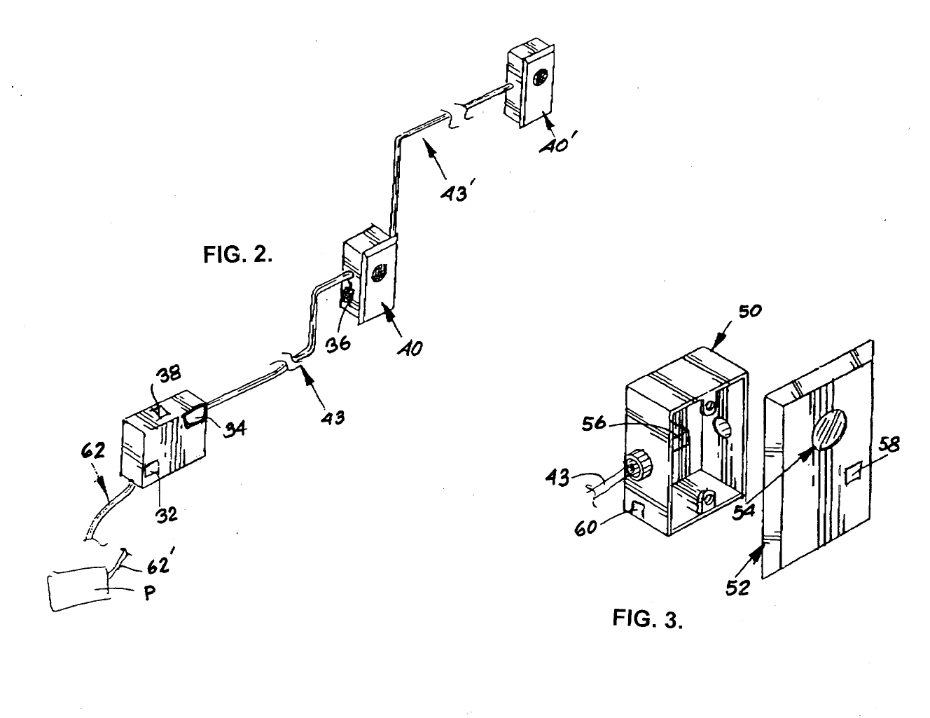

It is noted that the details of the particular elements indicated by boxes in FIG. 2 are not part of the invention and any off-the-shelf item can be used for the temperature sensing element 32, the signal generator 34, the alarm circuit 36 and/or the temperature level-setting circuit 38. Accordingly, the details of such elements will not be described in detail.

A first remote alarm unit 40 is located remote from the furnace 12. The alarm unit 40 can be positioned in a stairwell 42 or any other suitable location on the premises. The alarm unit can also be located off the premises as indicated for alarm 40′. Alarm 40′ can be located in a non-resident manager's office or in the home of a person taking care of building 16, or the like. The alarm unit is electrically connected to the alarm circuit of the sensor by landlines, such as electrical connectors 43 and 43′, to receive an alarm signal from the alarm circuit 36. Each of the remote alarm units includes a housing 50 which has a removable cover 52 with a speaker cover 54 therein.

An audible signal generator 56, such as a sound chip, a speaker or the like is located inside the housing 50 near the speaker cover 54 so sound generated by the generator 56 can be heard outside the housing 50. The details of the sound generator 56 will be understood by those skilled in the art and the particular details of the sound generator 56 do not form a part of the invention and thus will not be described in detail.

A visual signal generator 58 can also be located on the housing 50. The visual signal generator 58 can include a flashing light or a light that changes color when an alarm signal is received. As is the case with the sound generator 56, the details of the visual signal generator 58 will be understood by those skilled in the art and the particular details of the visual signal generator 58 do not form a part of the invention and thus will not be described.

An on/off control 60 is also located on each alarm unit so the alarm signal can be manually deactivated. System 10 can be powered from utility power connected to the premises being monitored by a power cord 62, or can be connected to an emergency power source P by a power cord 62′.

It is also noted that while the present invention has been disclosed in connection with a heating system, the system embodying the present invention can also be used in connection with a cooling system as well. The temperature sensors can be set so an alarm signal is generated when temperature rises to a pre-set level or when a cooling unit fails. Those skilled in the art will understand how the system embodying the present invention can be used in connection with a cooling system based on the teaching of the present disclosure.

It is understood that while certain forms of the present invention have been illustrated and described herein, it is not to be limited to the specific forms or arrangements of parts described and shown.

What is claimed and desired to be covered by letters patent is:

1. A furnace sensor and alarm system comprising:
a) a furnace which generates heated air;
b) a heated air exit fluidically connected to said furnace;
c) a sensor mounted on a support surface near said heated air exit, said sensor including
(1) a temperature sensing element,
(2) a signal generator in the temperature sensing element which generates an alarm signal when the temperature sensing element senses a temperature below a pre-set level,
(3) an alarm circuit connected to the signal generator of the temperature sensing element to receive an alarm signal from the signal generator and to be activated by the alarm signal received, and
(4) a temperature level setting circuit connected to the temperature sensing element to control the pre-set level at which the alarm signal is generated; and
d) a first remote alarm unit located remote from said furnace, said alarm unit being electrically connected to the alarm circuit of said senor to receive an alarm signal from the alarm circuit, said first remote alarm unit including
(1) a housing having a removable cover,
(2) an audible signal generator,
(3) a visual signal generator, and
(4) an on/off control.

2. The furnace sensor and alarm system as described in claim 1 further including a second remote alarm unit located remotely from said first remote alarm unit.

3. The furnace sensor and alarm system as described in claim 2 wherein said first and second remote alarm units are each mounted on an associated support surface.
